(19) United States
(12) Patent Application Publication
(10) Pub. No.: US 2017/0074404 A1
(43) Pub. Date: Mar. 16, 2017

(54) GRAPHENE-CONTAINING SLIDE RING

(71) Applicant: EagleBurgmann Germany GmbH & Co. KG, Wolfratshausen (DE)

(72) Inventors: Joachim Otschik, Beuerberg (DE); Jorg Thelke, Wolfratshausen (DE)

(73) Assignee: EagleBurgmann Germany GmbH & Co. KG, Wolfratshausen (DE)

(21) Appl. No.: 15/122,978

(22) PCT Filed: Feb. 9, 2015
(86) PCT No.: PCT/EP2015/052592

§ 371 Date: Sep. 1, 2016

(30) Foreign Application Priority Data
Mar. 21, 2014 (DE) DE102014205297.1

(51) Int. Cl. F16J 15/34; C04B 41/50; C04B 41/87; C04B 35/565; C04B 35/56

(52) U.S. Cl. CPC F16J 15/3496; C04B 35/565; C04B 35/5626; C04B 41/87; C04B 41/5002; F16J 15/3404; C04B 2235/422; C04B 2235/3826; C04B 2235/3847; C04B 2235/427

(57) ABSTRACT

The invention relates to a slide ring of a mechanical seal arrangement, produced from a graphene-containing material.

The present invention relates to a graphene-containing slide ring and to a mechanical seal arrangement having such a slide ring.

Graphene is a modification of carbon in a two-dimensional structure, wherein each carbon atom is surrounded by three further carbon atoms. This produces a honeycomb-shaped (hexagonal) pattern. Furthermore, essentially mechanical seals having a rotating slide ring and a stationary slide ring are known and permit sealing on rotating components. A material for slide rings is silicon carbide (SiC) or tungsten carbide (WC). These materials are particularly well suited for slide rings because they combine high levels of abrasion resistance with relatively high thermal conductivity. Furthermore, DE 102011056896 A1 discloses a method for producing and using graphene on polycrystalline silicon carbide for bearing components. In this case, graphene is applied to a surface of the silicon carbide, in order to create surfaces having very low friction.

After the silicon carbide surface has been polished, an annealing treatment is performed using flowing argon. Essentially, the known slide rings consisting of silicon carbide have proven to be successful. However, by reason of increasing requirements in terms of rotational speeds of machines and temperatures it would also be desirable to achieve increases in the service life of slide rings.

Therefore, it is the object of the present invention to provide a slide ring and a mechanical seal arrangement which has an improved thermal behaviour and a longer service life whilst having a simple structure and being simple and cost-effective to produce.

This object is achieved by a slide ring having the features of claim 1 and by a mechanical seal arrangement having the features of claim 16. The dependent claims describe preferred developments of the invention.

The slide ring in accordance with the invention having the features of claim 1 is produced from a material which comprises a slide ring material (base material) and a graphene-containing material. The graphene-containing material forms with the slide ring material a composite material, in which the slide ring material and the graphene-containing material are mixed. Therefore, by introducing the graphene-containing material into the material for the slide ring, improved thermal conductivity as well as improved electrical conductivity can be achieved. Furthermore, improved mechanical properties are achieved, in particular in terms of fracture toughness which can be significantly increased. Growth of cracks which can occur in the case of ceramic materials of slide rings during operation, is improved by a factor of 2 to 3 by means of the graphene-containing material, i.e. growth of cracks is retarded accordingly. The two-dimensional structure of the graphene-containing material in the slide ring renders it possible for cracks to be diverted, branched or bridged. In particular, this can significantly improve the service life of the slide ring.

The graphene-containing material is preferably graphene in the form of pure graphene and/or graphene oxide and/or technically reduced graphene oxide (TRGO) and/or functional graphene (graphene with attached further molecules or further attached atoms).

Preferably, the slide ring is produced from a ceramic material and the graphene-containing material.

Also preferably, the ceramic material and the graphene-containing material are mixed in the composite material.

In a particularly preferred manner, the slide ring is produced exclusively from the two materials, namely a single ceramic material and the graphene-containing material. In a particularly preferred manner, the ceramic material is SiC or WC or silicon nitride (Si₃N₄).

In a particularly preferred manner, the ceramic material and the graphene-containing material are evenly distributed in the slide ring. This means that the slide ring has identical mechanical, thermal and electrical properties throughout.

In a particularly preferred manner, the slide ring is a sintered component. Preferably, in this case the ceramic material is firstly mixed in powder form with the graphene-containing material and is rendered into the desired form e.g. by means of a pressing procedure. Optionally, a binding agent can be used in this case.

In a particularly preferred manner, the material for the slide ring is provided such that a weight proportion of the graphene-containing material in terms of the total weight of the slide ring is in a range of 0.1 to 10 wt. %, in particular 1 to 5 wt. %.

Also preferably, the proportion of graphene in the ceramic material is selected such that the slide ring has a resistivity in a range of 0.1 to 10 Ωm, in particular 0.3 to 0.8 Ωm.

In accordance with a further preferred embodiment of the present invention, the graphene-containing material is arranged in the material of the slide ring in the form of graphene parts such that each graphene part has in each case a multiplicity of individual graphene layers which are arranged directly in parallel with one another. The number of graphene layers arranged directly in parallel with one another is in a range of preferably 100 to 1000 layers. The number of graphene layers in the composite material can be different from graphene part to graphene part.

Also preferably, the graphene is arranged in the material of the slide ring such that the ceramic material completely surrounds individual graphene constituents. As a result, the graphene constituents present in the material have no direct contact with adjacent graphene constituents. The graphene constituents can be individual graphene layers or graphene parts consisting of a multiplicity of graphene layers.

Preferably, the graphene-containing material is provided in the material of the slide ring such that the graphene-containing material provides a continuous connection, which extends through the slide ring, from a slide side of the slide ring to at least one rear side of the slide ring. This can ensure particularly effective thermal conduction and also particularly effective electrical conduction from the slide side to the outer side of the slide ring. The outer side of the slide ring can be an inner or outer radial side or the rear side. In a particularly preferred manner, the material of the slide ring has a graphene network provided therein which is formed by individual graphene constituents which are in contact with one another.

Also preferably, the slide ring has a diamond coating on the slide surface. As a result, the slide ring has particularly effective wear resistance.

The present invention also relates to a mechanical seal arrangement having a rotating slide ring and a stationary slide ring, wherein at least one of the slide rings comprises a graphene-containing material. Preferably, both slide rings of the mechanical seal arrangement are produced from graphene-containing material. More preferably, the slide rings do not have a coating or alternatively have a diamond coating.

Preferred exemplified embodiments of the invention will be described in detail hereinafter with reference to the accompanying drawing. Like or functionally identical parts are designated in the drawing in each case by like reference signs. In the drawing:

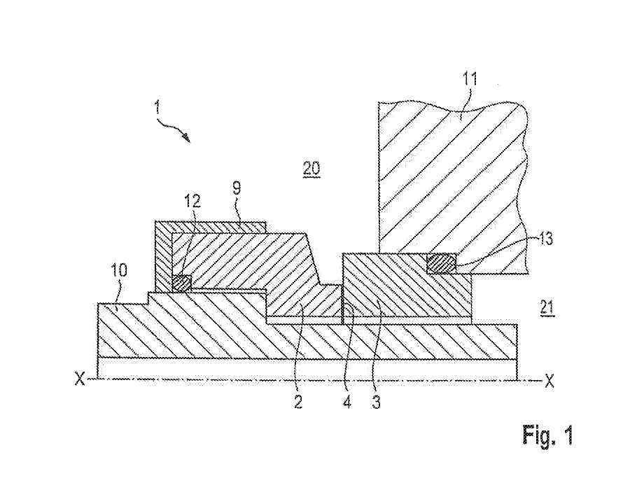

FIG. 1 shows a schematic sectional view of a mechanical seal having a slide ring in accordance with the invention in accordance with a first exemplified embodiment of the invention;

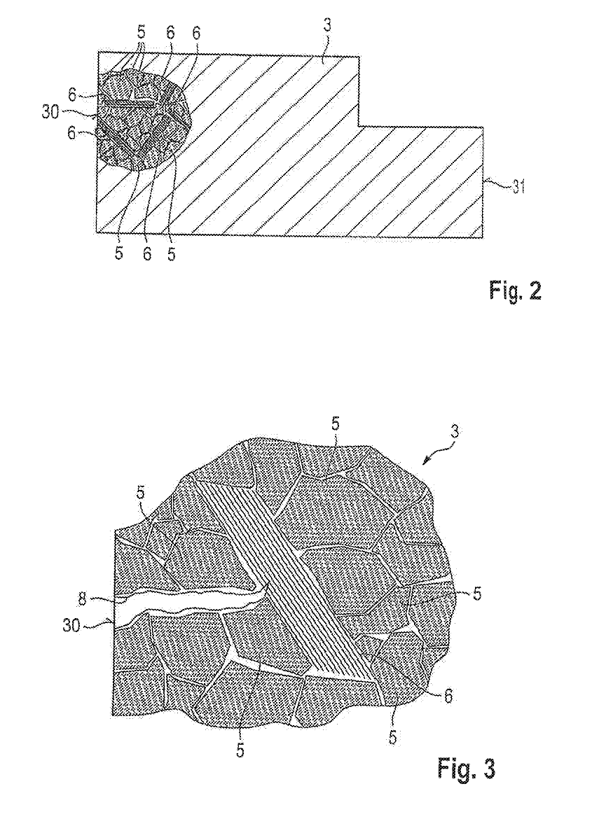

FIG. 2 shows a schematic sectional view of the slide ring shown in FIG. 1; and

FIG. 3 shows a schematic view of a crack extending through the slide ring, and

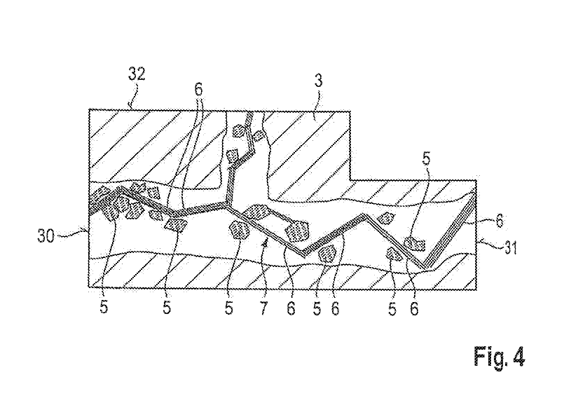

FIG. 4 shows a schematic sectional view of a slide ring in accordance with a second exemplified embodiment of the invention.

FIG. 1 schematically shows a mechanical seal arrangement 1 having a rotating slide ring 2 and a stationary slide ring 3. A sealing gap 4 is defined between the two slide rings 2, 3 in a known manner. The rotating slide ring 2 is connected to a rotating component 10, e.g. a shaft sleeve or the like, via an entrainment element 9. References signs 12 and 13 designate O-rings. The stationary slide ring 3 is connected to a stationary component 11, such as e.g. a housing or the like.

The mechanical seal arrangement 1 seals a product region 20 from an atmosphere region 21.

The stationary slide ring 3 is shown in detail in FIG. 2. The stationary slide ring 2 is produced from a composite material which comprises a ceramic material 5 and a graphene-containing material 6. The graphene-containing material 6 is evenly distributed in the composite material of the slide ring. The graphene-containing material can be pure graphene and/or graphene oxide and/or technically reduced graphene oxide and/or functional graphene, in which at least one other chemical molecule is attached, or can be any combination of the aforementioned materials.

As illustrated in the detail of FIG. 2, the graphene-containing material 6 is arranged, in the form of a multiplicity of graphene parts, in the ceramic material 5. The graphene parts comprise in each case a multiplicity of graphene layers which are arranged in parallel with one another. The number of graphene layers per graphene part is between 100 and 1000. The individual graphene parts can contact one another within the composite material or they are completely surrounded by crystals of the ceramic material 5, so that there is no contact with adjacent graphene parts. The ceramic material is preferably SiC.

The stationary slide ring 3 of this exemplified embodiment is a sintered component, wherein, in order to produce the slide ring, a ceramic powder is mixed with the graphene-containing material in a first step, in order to provide a sintering powder. In this case, graphene-containing material is admixed in a range of 0.1 to 10 wt. % and in particular 1 to 5 wt. % of the total weight of the sintering powder. In a next step, a green body is formed from the sintered powder mixture which is subsequently sintered.

The admixing of graphene-containing material to the ceramic sintering material produces against expectation a slide ring consisting of a composite material which offers unexpected advantages whilst retaining its strength. In addition to a significantly improved, particularly low resistivity of up to 0.1 Ωm, the fracture toughness of the material of the slide ring is also considerably improved.

In the case of typical slide rings consisting of ceramic material, such as e.g. SiC, cracks can occur after a certain operating period and frequently extend, starting from the slide surface, through the entire slide ring. Such damage can be substantially avoided in the case of a slide ring in accordance with the invention having a graphene proportion. It has proven to be the case that the graphene parts prevent crack growth of a crack 8 through the entire component. The cracks typically occur substantially perpendicularly with respect to the slide surface of the slide ring and then extend in an axial direction X-X through the entire slide ring. The graphene parts which consist of a multiplicity of mutually parallel individual graphene layers significantly retard the crack progress rate. If a crack 8 impinges upon a graphene part consisting of a multiplicity of graphene layers, the graphene layers do not all crack at the same time but rather individually. As a result, a propagation rate of a crack 8 through the component is significantly reduced. Therefore, the slide ring in accordance with the invention has a considerably longer service life than the conventional slide rings. Crack formation is indicated schematically in FIG. 3.

In the case of a slide ring consisting of pure SiC, the crack would run along the grain boundaries of the ceramic material through the entire component in an extremely short amount of time.

As is also evident in FIG. 2, some graphene parts are arranged in the slide ring such that they are at least partially exposed on the surface of the slide surface 30. This offers further advantages in terms of a reduced coefficient of friction, in particular in the event of dry operation of the mechanical seal arrangement. In this case, during dry operation, small segments of the graphene parts are presumably broken off and form a type of lubricant. Therefore, an improved dry running property of such a mechanical seal arrangement can also be achieved. In a particularly preferred manner, the stationary slide ring 3 and also the rotating slide ring 2 are produced from the material in accordance with the invention, comprising a ceramic material 5 and graphene-containing material 6.

FIG. 4 shows a slide ring 3 in accordance with a second exemplified embodiment of the invention. In contrast to the first exemplified embodiment, the second exemplified embodiment comprises an arrangement of the graphene-containing material 6 such that individual graphene parts form a continuous connection through the slide ring from the slide surface 30 to a rear side 31 and to further outer sides of the slide ring. By way of example, FIG. 4 also illustrates a continuous graphene connection to a radial outer side 32. Mutually adjacent graphene parts contact one another and are each arranged at different angles with respect to one another. In a particularly preferred manner, the continuous connection from the slide surface 30 to the rear side 31 or the outer sides is formed as a network-like structure 7. Therefore, many direct connection paths are produced by a wide variety of graphene parts, which are arranged in the manner of a network, from the slide surface 30 to the rear side 31 or further outer sides. Therefore, in particular the electrical conductivity of the slide ring 3 can be significantly improved. The reason for this resides in the fact that the graphene has a considerably higher electrical conductivity than the ceramic material, e.g. SiC. The improved electrical conductivity can be used specifically in conjunction with a current circuit across the slide ring or can also be used to reduce electrostatic charges on the slide surface 30.

### LIST OF REFERENCE SIGNS

1 mechanical seal arrangement
2 rotating slide ring
3 stationary slide ring
4 sealing gap
5 ceramic material
6 graphene-containing material
7 graphene network
8 crack
9 entrainment element
10 rotating component
11 housing
12, 13 sealing rings
20 product region
21 atmosphere region
30 slide surface
31 rear side
X-X axial direction

1. Slide ring of a mechanical seal arrangement, comprising a graphene-containing material.

2. Slide ring as claimed in claim 1, wherein the graphene-containing material comprises graphene in the form of pure graphene and/or graphene oxide and/or technically reduced graphene oxide and/or functional graphene.

3. Slide ring as claimed in claim 1, wherein the material of the slide ring is a composite material, comprising a ceramic material and the graphene-containing material.

4. Slide ring as claimed in claim 3, wherein the slide ring comprises exclusively the ceramic material and the graphene-containing material.

5. Slide ring as claimed in claim 3, wherein the ceramic material and the graphene-containing material are mixed in the composite material.

6. Slide ring as claimed in claim 3, wherein the ceramic material and the graphene-containing material are evenly distributed in the slide ring.

7. Slide ring as claimed in claim 1, wherein the slide ring is a sintered component.

8. Slide ring as claimed in claim 1, wherein a weight proportion of the graphene-containing material in terms of the total weight of the slide ring is in a range of 0.1 to 10 wt. %, in particular 1 to 5 wt. %.

9. Slide ring as claimed in claim 1, wherein the slide ring has a resistivity in a range of 0.1 to 10 Ωm.

10. Slide ring as claimed in claim 1, wherein the graphene-containing material of the slide ring is distributed in the form of graphene parts such that each graphene part has a multiplicity of individual graphene layers which are arranged directly in parallel with one another.

11. Slide ring as claimed in claim 3, wherein the ceramic material completely surrounds individual graphene constituents.

12. Slide ring as claimed in claim 1, wherein the slide ring has a slide surface and an outer side and wherein a continuous connection established from graphene-containing material is formed between the slide surface and the outer side.

13. Slide ring as claimed in claim 12, wherein the connection is formed by a graphene network consisting of graphene parts in the slide ring.

14. Slide ring as claimed in claim 1, wherein graphene-containing material is arranged on a slide surface of the slide ring.

15. Slide ring as claimed in claim 14, wherein the slide ring has a diamond coating on the slide surface.

16. Slide ring as claimed in claim 3, wherein the ceramic material is SiC or WC or silicon nitride.

17. Mechanical seal arrangement having a rotating slide ring and a stationary slide ring, wherein at least one of the slide rings is a slide ring as claimed in claim 1.
